(19) United States
(12) Patent Application Publication
(10) Pub. No.: US 2023/0042007 A1
(43) Pub. Date: Feb. 9, 2023

(54) VENTILATION DUCT UNIT

(71) Applicant: FläktGroup Sweden AB, Jönköping (SE)

(72) Inventors: Jari MIKKONEN, Akaa (FI); Jari HOKKANEN, Akaa (FI); Timo KAASALAINEN, Akaa (FI)

(21) Appl. No.: 17/787,108

(22) PCT Filed: Dec. 18, 2020
(86) PCT No.: PCT/EP2020/087038

§ 371 Date: Jun. 17, 2022

(30) Foreign Application Priority Data
Dec. 19, 2019 (FI) 20196102

(51) Int. Cl. A62C 2/12; F16K 17/38; F24F 11/35; F24F 13/02; F24F 13/24

(52) U.S. Cl. CPC A62C 2/12; F16K 17/386; F24F 11/35; F24F 13/0263; F24F 13/24; F24F 2013/242

(57) ABSTRACT

The object of this invention is a ventilation duct unit (1), which comprises an inlet (2), an outlet (3), a flow channel (4), which extends from the inlet to the outlet, and which is delimited by a wall (5) between the inlet and the outlet, a closing part (6), which is arranged into the flow channel, and which in open position enables flow in the flow channel, and in closed position prevents flow in the flow channel, closing member (12), which as a response to detecting fire, sets the closing part (6) to a predetermined position, and an actuator (8), which moves the closing part (6) between open and closed state in order to achieve flow defined for the actuator (8) in the flow channel. In order to utilize the ventilation duct unit for controlling fire situations and sound dampening, the ventilation duct unit further comprises insulation material (14), part of which is fireproof, and which surrounds the wall (5) of the flow channel and isolates the surrounded part of the wall of the flow channel from its surroundings, and holes (18) arranged in the surrounded part of the wall of the flow channel (4), which dampen sound by leading the medium flowing in the flow channel to be in contact with insulation material (14).

### FIELD OF INVENTION

The invention relates to a ventilation duct unit, and in particular to a solution, that can be used to achieve savings in terms of space and costs when implementing a ventilation duct.

### BACKGROUND ART

When implementing a ventilation duct, other aspects to consider besides implementing efficient and energy economic ventilation, is also fire safety and sound dampening. In practice the ventilation duct must be implemented in a way that airflow is efficient, but in case of fire, spreading of the fire is stopped, and also during the use it is required to dampen sounds, so they don't continue to propagate further.

In known solutions the above-mentioned attributes have been implemented by arranging a ventilation duct unit, that has an actuator and a control part, which are used to implement an airflow of a desired magnitude, into the ventilation duct. Fore fire situations, a ventilation duct unit that has a fire damper for fire situations, is arranged into the ventilation duct. Further for dampening sounds, a ventilation duct unit with a sound dampener, is arranged into the ventilation duct. With this implementation, all required attributes are reached.

However, the problem with the above-mentioned solution, is that it requires arranging multiple different ventilation duct units after each other into the ventilation duct. In practice each ventilation duct unit reserves space, in addition to which the control required by the ventilation duct units requires effort in both planning phase and installation phase, so that the required cabling and functions can be implemented.

### SUMMARY OF INVENTION

The object of the invention is to solve the above described problem and to offer a solution that enables saving space and cutting costs when implementing a ventilation duct. This object is achieved with a ventilation duct unit according to independent claim 1.

By utilizing a ventilation duct unit, which has a closing member which sets a closing part to a predetermined position in case of fire, an actuator which moves the closing part in order to achieve determined flow, and insulation material surrounding the flow channel of which at least part of is fireproof and to which the medium flowing in the flow channel gets in contact with, a ventilation duct unit is achieved, that can be utilized in controlling flow, controlling fire situations, and also in sound dampening. This way, a need to arrange multiple separate ventilation duct units into a ventilation duct is avoided, thus saving space and cutting costs.

### BRIEF DESCRIPTION OF DRAWINGS

The invention is further described in the following examples by referencing enclosed figures, of which:

FIG. 1 presents a first preferred embodiment of the ventilation duct,

FIG. 2 presents a cross section of the ventilation duct unit of FIG. 1, and

FIG. 3 presents a second preferred embodiment of the ventilation duct.

### DESCRIPTION OF AT LEAST ONE EMBODIMENT

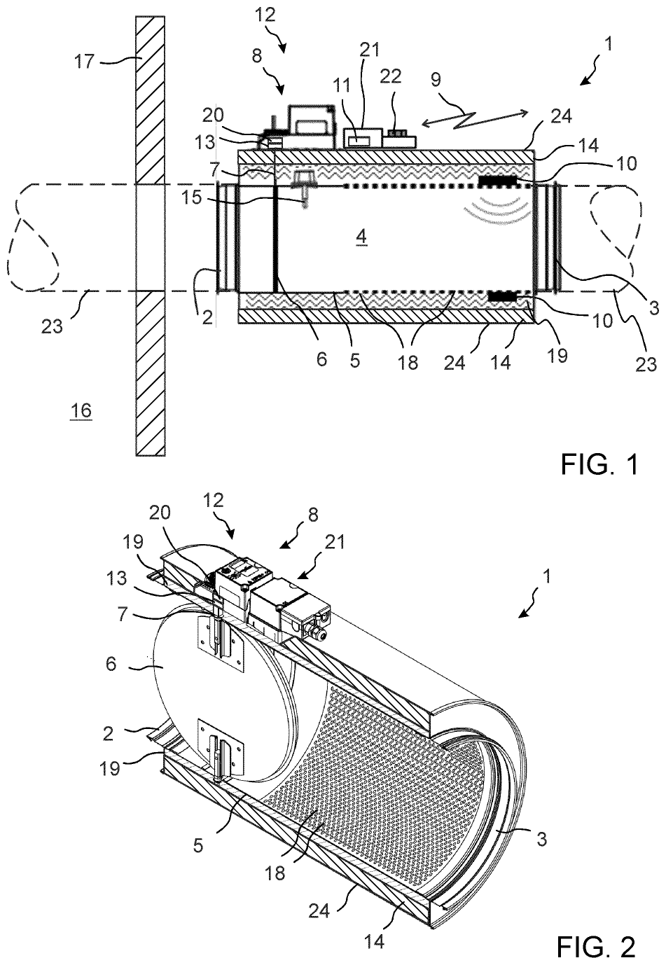

A ventilation duct unit described in FIGS. 1 and 2 comprises a flow channel 4, which extends from an input opening 2 to an output opening 3, and which is delimited by a wall 5 between the input opening 2 and the output opening 3. In the example case presented in the figures, the ventilation duct unit is shaped so that the wall 5 forms a cylindrical pipe, which has a diameter that can vary for example between 100-315 mm. In FIG. 1 the ventilation duct unit 1 is connected to a ventilation duct 23 which continues on both sides of the ventilation duct unit as a ventilation pipe.

A closing part 6 is arranged inside the flow channel 4, which closing part in the open position presented in FIG. 2, enables flow in the flow channel 4, and which closing part in the closed position presented in FIG. 1 prevents flow in the flow channel. The closing part 6 changes position between the open and the closed position by rotating in the flow channel about axis 7.

In a normal situation, which is when the ventilation duct unit 1 is used to control airflow through the ventilation duct, an actuator 8 moves the closing part 6 between open and closed position by rotating it about the axis 7 in order to achieve flow defined for the actuator in the flow channel 4. For this purpose, there can be for example an electric motor integrated into the actuator, which electric motor is controlled by the control unit of the actuator by utilizing content of its memory. Thus, the actuator 8 controls the position of the closing part 6 according to a command coming from the controller. In addition, the actuator can pass information about the true position of the closing part 6 to the controller of the actuator. In the example case presented in the figures, the control unit of the actuator and the fire testing unit 21 are implemented as an integrated part, which is a very cost-efficient solution. The user can save a set value to be utilized in the controlling of airflow according to temperature or CO₂ concentration to the memory 11, locally via an user interface, or alternatively via wired or wireless communications link 9, which is used to connect the ventilation duct unit to a separately located control centre which is included in the building automation (not presented in figures). The control unit of the actuator in that case compares measured flow against the set value and controls the actuator 8 based on this. Additionally, control unit of the actuator can pass information about the measured flow to a control centre.

In the example presented in figures, also a member 10 for measuring flow is arranged inside the flow channel 4 of the ventilation duct unit 1, in which case the control unit of the actuator 8 receives information of the measured flow, and based on this measurement and set value sends a message to the actuator 8, which moves the closing part 6 in order to achieve the defined flow assigned by the set value. The ventilation duct unit can so function as a VAV-controller (Variable Air Volume) for example in an apartment, in a hotel, in an office, in a school or in health care facilities. Member 10, which is used for measuring the flow, can in practice be made up of an ultrasonic sensor, which includes an ultrasonic transmitter and an ultrasonic receiver. Power supply for the member 10 can be implemented from the control unit of the actuator 8, which in practice also receives information of the measured flow and also of the temperature measured by member 10, if a member that is capable of measuring temperatures is used.

The ventilation duct unit 1 also includes a closing member 12, which in the example cases of the figures is implemented as a part of the actuator 8. In this example case the closing member 12 implemented as a part of the actuator 8, comprises a spring 13, for example a coil spring, which in case of fire sets the closing member 6 to a predetermined position with spring force by rotating about axis 7. Due to spring force, the closing member 12 ensures that the predetermined position is achieved also when electricity is not available. Detection of fire can be done by ventilation duct unit 1, for example so that one or more thermal fuses 15 are arranged inside the flow channel 4, which allows the actuator 8 to track the temperature. In the example case of the figures, one thermal fuse 15 is located in the channel and a second thermal fuse can be integrated in the actuator 8 itself. In practice the power supply from the control unit of the actuator to the actuator 8 can be implemented through a thermal fuse or through more than one thermal fuses, so that blowing of even one thermal fuse shuts off the power supply to the actuator 8. When the temperature reaches a threshold value set for detecting fire, a thermal fuse 15 blows, in which case the actuator 8 or its control unit triggers the closing member 12 to set the closing part 6 to a predetermined position. Alternatively, the actuator can detect fire based on the signal relayed through its communications link 9. In this case the thermal fuse or for example a smoke detector can be arranged separately from the ventilation duct unit, in which case the signal is relayed to the actuator, for example from a separately located control centre. For example, a part that breaks down mechanically if the threshold temperature is exceeded can be used as a thermal fuse.

The actuator 8 or its control unit can trigger the closing member 12 to set the closing part 6 to a predetermined position for example so, that when fire is detected, the actuator 8 stops moving the closing part 6. In that case only the spring force of spring 13 affects the closing part 6, in which case the spring force takes the closing part 6 to the predetermined position. What this predetermined position is, varies due to for example the location of the installation and regulations set by the authorities. One option is that as a response to detecting fire, the closing member 12 sets the closing part 6 to a closed position presented in FIG. 1. In that case, for example spreading of the fire through the ventilation duct unit is prevented. Alternatively, the closing member 12 can, as a response to detecting fire, set the closing part 6 to an open position presented in FIG. 2. In that case, for example airflow can be ensured into a desired space or out of a desired space through the ventilation duct unit in case of fire.

In the example of the figures, ventilation duct unit 1 comprises a fireproof insulation material layer 14 which surrounds the wall 5 of the flow channel 4 and isolates the surrounded wall part of the flow channel 4 from its surroundings. In practice, the ventilation duct unit 1 can be implemented so, that its wall has a dual structure, in which case in addition to the wall 5 that delimits the flow channel 4, the ventilation duct 1 also features an outer wall 24, which encloses the wall 5 of the flow channel 4 and the fireproof insulation material 14 that surrounds it. In practice, both the wall 5 and the outer wall 24 can be made of metal, for example steel. Alternatively, the wall 5 can be for example implemented with coated mineral wool or other fireproof damping material.

In case of fire, where the fire ignites in space 16, which is on the other side of a partition wall 17 of a building from the ventilation duct unit 1, the closing part 6 of the ventilation duct unit 1 can in the situation of FIG. 1 by closing, stop the spreading of the fire from space 16 into a space located on the right in FIG. 1 via airflow through the partition wall. However, in that case a rise in the temperature of the outer surface of the ventilation duct unit 1 can cause a problem. To prevent this and to follow regulations set by the authorities, the fireproof insulation material 14 can be designed so that the temperature of the outer wall 24 stays inside defined thresholds. A suitable insulation material for this purpose is for example mineral wool.

One advantage that is gained with an effective fireproof insulation layer 14 is, that the closing part 6 can be designed to be thin compared to thickness of known fire dampers, which often have to be designed to be even 30 mm thick. In practice, the closing part can be implemented as a closing flap, which can have a thickness of for example 20 mm or even less. This is because heat transferring from space 16 located on the left in FIG. 1 through closing part 6 to right into the flow channel 4, does not cause direct harm or danger, because the insulation layer 14 of the ventilation duct unit 1 prevents in this case the transfer of this heat load through its outer wall 24 into the space surrounding it. A significant advantage can be achieved with a thin closing part, because when controlling the airflow through the ventilation duct unit 1 in normal state, it is significantly easier to implement accurate controlling than if using a thick closing part 6. In addition, a thick closing part causes a larger pressure loss and develops more disturbing sound.

From FIGS. 1 and 2 it is observed that holes 18 are formed in the wall 5 that is surrounded by the fireproof insulation material 14. The medium, such as air, flowing in the flow channel 4 is brought into contact with the insulation material through these holes. The size and number of the holes varies based on the implementation. One alternative is to for example use holes with 3 mm diameter so that on the holed area of the wall, area of the holes is approximately 30% of the total area of the holed area. In this case, efficient sound dampening is achieved by utilizing the insulation material. In the example presented in figures, the closing part 6 is arranged to a part of the flow channel 4, which does not have holes in its wall, in which case closing part 6 can close the flow channel tightly, without possible leaks caused by the holes.

Depending on the implementation, the space between the wall 5 of the flow channel 4 and the outer wall 24, can be filled by using one single fireproof insulation material, or alternatively more than one different insulation materials can be arranged in this space. One alternative, which is illustrated as an example in FIGS. 1 and 2, is that a layer structure is used. In this case, closest to wall 5, insulation material 19 can be used, which achieves the best possible sound reduction, so that flow noise created in flow channel 4 can be efficiently prevented from transferring through outer wall 24 to the surroundings. The inner insulation material 19 can be surrounded by a layer made of fireproof insulation material 14.

As the above shows, the same ventilation duct unit formed of single part is suitable to be used in a ventilation duct as a fire damper, as a sound dampener, and as a controller of the airflow. This is a significant advantage, because it makes it possible to avoid implementing these functions with multiple ventilation duct units set one after another, in which case the need for space is reduced to under halve of the needed space compared to traditional solutions. Also, flow loss caused by a traditional fire damper in the flow channel can be avoided. In addition, in planning, in installing, and in cabling the needs of only one ventilation duct unit need to be considered, in which case the cost savings are significant.

The ventilation duct unit 1 illustrated in figures also includes a position switch 20 of the closing part, which is in first state, when closing part 6 is in predetermined position (meaning the position, which the closing member sets it to in case of fire), and which is in second state, when the closing part is not in said predetermined position. In practice the position switch 20 can be implemented for example with a simple mechanical switch, which has a moving part that closes an electric circuit, which moving part is touched and pressed by closing part 6, closing member 12, actuator 8 or axis 7 which moves the closing part, when the closing part reaches a predetermined position. In this case the fire testing unit receives information, that the closing part 6 is in a predetermined position.

In the example case of the figures, it is assumed that the fire testing unit is implemented as a part of the control unit of the actuator 8. In this case it is an integrated and very cost-efficient solution. In practice the fire testing unit can be implemented for example as a program, which is implemented by a processor of the control unit of the actuator by utilizing data saved in a memory 11. At predetermined times, the fire testing unit triggers an automatic testing of the fire safety function, where the closing part 6 is set to a predetermined position. Alternatively, testing of the fire safety function can activate through a control signal via the communications link 9, that is sent from a separately located control centre, in which case the fire testing unit triggers testing of the fire safety functions as a result of such activation. Accordingly, after detecting fire, this can happen in such way, that the actuator 8 stops moving the closing part, in which case the spring force of the spring 13 takes the closing part 6 to a predetermined position. In practice, the fire testing unit 21 can cut the power supply to the actuator 8 in order to test the fire safety function.

After triggering the fire safety function, the fire testing unit 21 tracks the state of the position switch 20 to determine if the state of the position switch changes in a predetermined way between the first and the second state after triggering. The exact way the state of the position switch should change “in a predetermined way” can vary from one implementation to another.

One alternative is, that the fire testing unit 21 detects that the state of the position switch 20 has changed in a predetermined way, when it detects that the position switch is in first state after triggering the test. In this case, the fire testing unit can indicate that testing of the fire safety function was successful.

Alternatively, one option is that the fire testing unit gives an indication of the success of the testing only when the position switch has moved to first state (closing part 6 has reached a predetermined position) in first stage after triggering, and when the fire testing unit after this in second stage has returned the power supply to the actuator 8, and the fire testing unit 21 detects that the position switch is no longer in first state (closing part 6 has moved off of the predetermined position).

Indication can happen locally with an indicator, such as a LED 22, that is connected to the ventilation duct unit 1. In addition to this or alternatively, indication can happen in a way that the fire testing unit 21 sends a predetermined signal via the connections link 9 from the ventilation duct unit 1 to a separately located control unit. By implementing the fire testing unit as an integrated part of the ventilation duct unit, compared to an alternative where testing of the fire safety function is implemented by a separate control system, an advantage is gained in simplifying cabling, installation and implementation. Thus, cost savings are achieved and in addition the time needed for installation shortens.

After triggering testing of the fire safety function, the fire testing unit 21 aborts the fire safety testing by activating the actuator to again move the closing part when the testing of the fire safety function is successful, or when a predetermined amount of time has passed after triggering testing of the fire safety function, without the testing of the fire safety function being successful. In practice, in this case, testing of the fire safety function has failed. The fire testing unit can indicate failed testing of the fire safety function locally with the indicator 22 or with a message to the control unit via the communications link 9.

In order for testing of fire testing function to be done automatically at times required by authorities, the fire testing unit 21 maintains a calendar in memory 11, which in practice is data that allocates the times when testing of the fire testing function is to be triggered. A clock is implemented in the fire testing unit 21, in which case based on the clock and this data, the fire testing unit is capable of independently triggering and implementing testing of the fire testing functions at determined times. Testing of the fire safety functions implemented in this way can be started and finished automatically also when the ventilation duct unit in question is in use and controlling the airflow of a room space, because completing the testing event of the fire safety functions is very fast, making the disruption to implemented airflow minimal.

An example of the ventilation duct unit is described above by referring to an input opening and an output opening, flow being implementable between thereof. In practice the same described ventilation duct unit can be utilized in controlling flows flowing in both directions. So, if the flow direction is for example temporarily in the example case presented in FIGS. 1 and 2 from right to left, the hole 3 located on right side functions in this case as the input hole and the hole located on the left as the output channel.

In the context of FIGS. 1 and 2, it is as an example illustrated, that the wall 5 delimits the flow channel, and the wall has holes through which the medium flowing in the flow channel can reach contact with the insulation material. However, deviating from this, it is possible, that the surface of the insulation material facing the flow channel forms this wall. In that case, the surface of the insulation material can be coated with a suitable material. In any case, the need for using a separate wall from the insulation material can be avoided, and thus no holes are needed to form on such wall, as flow gets in contact with the insulation material even without the holes.

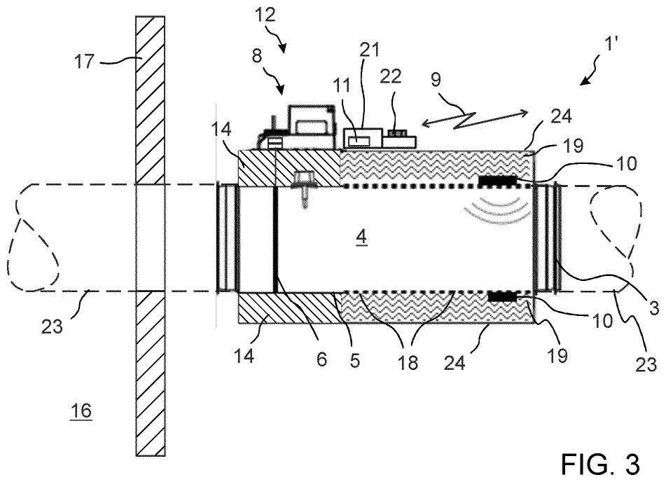

FIG. 3 illustrates a second embodiment of the ventilation duct unit 1′. The embodiment of FIG. 3 matches largely the embodiment illustrated in FIGS. 1 and 2. This is why the embodiment of FIG. 3 is primarily described in the following by referring to the differences between these embodiments.

Also the embodiment of FIG. 3 illustrates the use of first insulation material 14 and the use of second insulation material 19 in the space between the flow channel wall 5 and the outer wall 24. However, in the embodiment of FIG. 3 the insulation material has been arranged into zones. The insulation material 14 with the best fireproof qualities is arranged into a first zone that is closest to the closing part 6, and which surrounds the flow channel for part of the length of the flow channel 4. The insulation material 19 with the best sound dampening qualities is arranged into a second zone, which is located at the site of the holes 18, and which surrounds the flow channel for part of the length of the flow channel 4. So, the end result is a solution, wherein the best fireproofing is reached in that part of the ventilation duct unit 1′, which has the highest temperature as a result of a fire in space 16, and which reaches the best sound dampening in the holed part formed for optimizing sound dampening.

In practice, deviating from FIGS. 1-3, it is also possible to utilize both layered, and zone divided insulation in the same ventilation duct unit. In that case, for example insulation materials 14 and 19 of FIG. 3 can be surrounded over the length of the whole ventilation duct unit with an additional layer of insulation, where a third insulation material, or alternatively one of the two insulation materials 14 or 19, can be used.

It is to be understood that the above description and the accompanying figures are only meant to illustrate the presented invention. It will be apparent to a person skilled in the art that the invention can be modified also in other ways without departing from the scope of the invention.

1. Ventilation duct unit comprising
an inlet,
an outlet,
a flow channel, which extends from the inlet to the outlet, and which is delimited by a wall between the inlet and the outlet,
a closing part, which is arranged in the flow channel, and which in an open position enables flow in the flow channel, and in a closed position prevents flow in the flow channel, and
a closing member which as a response to detecting fire, sets the closing part to a predetermined position, and
an actuator, which moves the closing part between the open and the closed state in order to achieve flow defined for the actuator in the flow channel,
wherein
the ventilation duct unit further comprises:
insulation material which surrounds the flow channel and is in contact with medium flowing in the flow channel, in which case
at least a part of the insulation material surrounding the flow channel is fireproof.

2. Ventilation duct unit according to claim 1, wherein insulation material surrounds the wall of the flow channel, and isolates the surrounded part of the wall of the flow channel from its surroundings, and
holes are arranged to the surrounded part of the wall of the flow channel, which dampen sound by leading the medium flowing in the flow channel to be in contact with insulation material.

3. Ventilation duct unit according to claim 1, wherein a closing member as a response to detecting fire sets the closing part to the closed position.

4. Ventilation duct unit according to claim 1, wherein the closing member as a response to detecting fire sets the closing part to the open position.

5. Ventilation duct unit according to claim 1, wherein the closing member comprises a spring, spring forces of which set the closing part to a predetermined position.

6. Ventilation duct unit according to claim 1, wherein there is a member in the flow channel, which measures flow, and that the actuator moves the closing part according to measured flow in order to achieve defined flow.

7. Ventilation duct unit according to claim 1, wherein the flow channel has a thermal fuse, and that the closing member sets the closing part to a predetermined position when the thermal fuse blows.

8. Ventilation duct unit according to claim 2, wherein the flow channel is surrounded by, in addition to the fireproof insulation material, for at least a part of the length of the flow channel a layer that includes a second insulation material.

9. Ventilation duct unit according to claim 2, wherein the holes are arranged into the flow channel after the closing part in flowing direction, so that the closing part is located in a part of the flow channel that does not have holes in its wall.

10. Ventilation duct unit according to claim 1, wherein the ventilation duct unit further comprises:
a position switch of the closing part, which is in a first state, when the closing part in said predetermined position, and which is in a second state, when the closing part is not in said predetermined position, and
a fire testing unit, which at predetermined times triggers testing of the fire safety functions, wherein the closing member sets the closing part to a predetermined position, and which after triggering testing of the fire safety functions, indicates that testing of the fire safety functions was successful, if the fire testing unit detects that the state of the position switch of the closing part has changed in a predetermined way between the first and the second state after the triggering.

11. Ventilation duct unit according to claim 10, wherein the fire testing unit detects that the state of the position switch of the closing part has changed in the predetermined way after the triggering, when the position switch has moved to the first state after the triggering.

12. Ventilation duct unit according to claim 10, wherein the fire testing unit detects that the state of the position switch of the closing part has changed in the predetermined way after the triggering, when the position switch has moved to the first state in a first stage after the triggering, and when after this the fire testing unit detects that the position switch of the closing part has moved to the second state in a second stage after aborting the testing of the fire safety functions.

13. Ventilation duct unit according to claim 10, wherein the fire testing unit indicates the success of the fire testing functions via an indicator connected to the ventilation duct unit.

14. Ventilation duct unit according to claim 10, wherein the fire testing unit indicates the success of the fire testing functions by sending a predetermined signal via a communications link to a control unit located separately from the ventilation duct unit.

15. Ventilation duct unit according to claim 10, wherein the fire testing unit comprises a clock, and a memory, to which data is saved which indicates the times at which the fire test is to be triggered, and the fire testing unit is arranged to trigger testing of the fire safety functions when the clock indicates a time which corresponds with the triggering time of testing of the fire safety functions saved in the memory.
